(19) United States
(12) Patent Application Publication
(10) Pub. No.: US 2001/0010050 A1
(43) Pub. Date: Jul. 26, 2001

(54) System, method and record medium for opening document to the public by use of public media

(75) Inventor: Kazuhiro Sakata, Tokyo (JP)

Correspondence Address: FOLEY & LARDNER, Washington Harbour, 3000 K Street, N.W., Suite 500, P.O. Box 25696, Washington, DC, 20007-8696, US

(73) Assignee: NEC CORPORATION

(21) Appl. No.: 09/766,641

(22) Filed: Jan. 23, 2001

(30) Foreign Application Priority Data
Jan. 24, 2000 (JP) 2000-017879

(51) Int. Cl. G06F 15/00

(52) U.S. Cl. 707/526; 707/530

(57) ABSTRACT

A data reception section of a document publication system receives document data that is inputted as an object of publication, and supplies the received document data to a data registration control section. The data registration control section which received the document data registers the document data in a data storage section. A data publication section publishes (opens to the public) the document data that has been registered in the data storage section by use of a public medium such as the Internet, television, radio, newspaper, magazines, etc., while the data registration control section records publication time of the document data by the data publication section in a management table. When there is a request for the verification of publication time of document data, the data registration control section searches the management table and the data storage section and thereby obtains the document data and publication time of the document data. A certificate issuing section converts the document data and the publication time to a format capable of preventing tampering of data, and sends the converted data to the requester of the verification as a certificate.

### BACKGROUND OF THE INVENTION

The present invention relates to a document publication system and a document publication method for opening documents concerning ideas to the public by use of public media.

### DESCRIPTION OF THE RELATED ART

When a person invented or devised a new idea and intends to secure the right to effectuate the idea as vocation, the person has to acquire a patent right, utility model right, etc. according to patent statute etc., or the person has to open the details of the idea to the public so that the idea will become public known. If such procedures are not done by the person and another person or company acquired a patent right concerning the same idea, the right to effectuate the idea as vocation is monopolized by the another person or company.

Therefore, a person who invented or devised a new idea used to acquire a patent right etc. according to law or make the idea public known by opening the details of the idea to the public in order to secure the right to effectuate the idea as vocation.

However, applications for the patent right, utility model right, etc. according to patent statute etc. takes much time and cost.

The publication of documents concerning ideas through mass media also takes too much cost since information distribution through mass media takes too much cost. The rapid spread of the Internet of these days is enabling the publication of documents concerning ideas on home pages by use of Web servers, however, the preparation and management of the server also takes considerable cost.

In the case where a person uses a Web server for the publication of a document concerning an idea, when opposition or trial for invalidation of patent has to be claimed with regard to a patent right of another person, the person claiming for the opposition or trial has to verify or prove the date and time of the publication of the document (that is, the date and time of the upload of the document to the server). Such verification of the publication time is difficult for a private individual.

As described above, it has been difficult for an inventor or devisor of an idea to open a document concerning the idea to the public at a low cost.

### SUMMARY OF THE INVENTION

It is therefore the primary object of the present invention to provide a document publication system and a document publication method by which a document concerning an idea invented or devised by a person can be opened to the public easily and at a low cost.

Another object of the present invention is to provide a document publication system and a document publication method by which the verification (proof of the date and time of the publication of the idea can be conducted easily and at a low cost.

In accordance with a first aspect of the present invention, there is provided a document publication system which records each document data that is inputted as an object of publication, publishes the document data by use of a public medium while recording publication time of the document data, and issues a certificate concerning the publication time of document data to a requester according to a publication time verification request by the requester designating the document data.

In accordance with a second aspect of the present invention, there is provided a document publication system for opening documents to the public. The document publication system comprises a data reception means, a data publication means, a data registration control means and a certificate issuing means. The data reception means receives document data that is inputted as an object of publication. The data publication means publishes the document data received by the data reception means by use of a public medium. The data registration control means records the document data received by the data reception means and records publication time of the document data by the data publication means. The certificate issuing means issues a certificate concerning the publication time of document data to a requester according to a publication time verification request by the requester designating the document data.

In accordance with a third aspect of the present invention, in the second aspect, the certificate issuing means converts the designated document data and data concerning the publication time of the designated document data to a format capable of preventing tampering of data and thereafter provides the converted data to the requester as the certificate.

In accordance with a fourth aspect of the present invention, in the third aspect, the certificate issuing means adds a digital signature to the designated document data and the data concerning the publication time and provides the data with the digital signature to the requester as the certificate.

In accordance with a fifth aspect of the present invention, in the second aspect, the data publication means publishes the document data together with a document ID of the document data. The certificate issuing means converts the document ID of the designated document data and data concerning the publication time of the designated document data to a format capable of preventing tampering of data and thereafter provides the converted data to the requester as the certificate.

In accordance with a sixth aspect of the present invention, in the fifth aspect, the certificate issuing means adds a digital signature to the document ID of the designated document data and the data concerning the publication time and provides the data with the digital signature to the requester as the certificate.

In accordance with a seventh aspect of the present invention, in the second aspect, the document publication system further comprises a format conversion means. The format conversion means converts the format of the document data received by the data reception means to a predetermined format when the format of the document data is not the predetermined format.

In accordance with an eighth aspect of the present invention, in the second aspect, the data publication means uses a public network as the public medium.

In accordance with a ninth aspect of the present invention, in the eighth aspect, the data publication means uses the Internet as the public network.

In accordance with a tenth aspect of the present invention, in the second aspect, the data publication means uses mass media as the public medium.

In accordance with an eleventh aspect of the present invention, in the tenth aspect, the data publication means uses broadcasting as the mass media.

In accordance with a twelfth aspect of the present invention, in the tenth aspect, the data publication means uses newspaper and/or magazines as the mass media.

In accordance with a thirteenth aspect of the present invention, in the second aspect, the document data is document data concerning an idea invented or devised by a person.

In accordance with a fourteenth aspect of the present invention, in the second aspect, the data reception means receives the document data from a client via a network.

In accordance with a fifteenth aspect of the present invention, in the second aspect, the document publication system further comprises a publication report means. The publication report means informs a requester who requested the document data publication about a document ID and publication time of the document data.

In accordance with a sixteenth aspect of the present invention, there is provided a document publication method, in which each document data that is inputted as an object of publication is recorded and published by use of a public medium while recording publication time of the document data, and a certificate concerning the publication time of document data is issued to a requester according to a publication time verification request by the requester designating the document data.

In accordance with a seventeenth aspect of the present invention, there is provided a document publication method for opening documents to the public. The document publication method comprises a data reception step, a data publication step, a data registration control step and a certificate issuing step. In the data reception step, document data that is inputted as an object of publication is received. In the data publication step, the document data received in the data reception step is published by use of a public medium. In the data registration control step, the document data received in the data reception step is recorded, and publication time of the document data by the data publication means is recorded. In the certificate issuing step, a certificate concerning the publication time of document data is issued to a requester according to a publication time verification request by the requester designating the document data.

In accordance with an eighteenth aspect of the present invention, in the certificate issuing step of the seventeenth aspect, the designated document data and data concerning the publication time of the designated document data are converted to a format capable of preventing tampering of data and thereafter the converted data is provided to the requester as the certificate.

In accordance with a nineteenth aspect of the present invention, in the certificate issuing step in the eighteenth aspect, a digital signature is added to the designated document data and the data concerning the publication time, and the data with the digital signature is provided to the requester as the certificate.

In accordance with a twentieth aspect of the present invention, in the data publication step in the seventeenth aspect, the document data is published together with a document ID of the document data. In the certificate issuing step, the document ID of the designated document data and data concerning the publication time of the designated document data are converted to a format capable of preventing tampering of data and thereafter the converted data is provided to the requester as the certificate.

In accordance with a twenty-first aspect of the present invention, in the certificate issuing step in the twentieth aspect, a digital signature is added to the document ID of the designated document data and the data concerning the publication time, and the data with the digital signature is provided to the requester as the certificate.

In accordance with a twenty-second aspect of the present invention, in the seventeenth aspect, the document publication method further comprises a format conversion step. In the format conversion step, the format of the document data received in the data reception step is converted to a predetermined format when the format of the document data is not the predetermined format.

In accordance with a twenty-third aspect of the present invention, in the seventeenth aspect, a public network is used as the public medium in the data publication step.

In accordance with a twenty-fourth aspect of the present invention, in the twenty-third aspect, the Internet is used as the public network in the data publication step.

In accordance with a twenty-fifth aspect of the present invention, in the seventeenth aspect, mass media is used as the public medium in the data publication step.

In accordance with a twenty-sixth aspect of the present invention, in the twenty-fifth aspect, broadcasting is used as the mass media in the data publication step.

In accordance with a twenty-seventh aspect of the present invention, in the twenty-fifth aspect, newspaper and/or magazines are used as the mass media in the data publication step.

In accordance with a twenty-eighth aspect of the present invention, in the seventeenth aspect, the document data is document data concerning an idea invented or devised by a person.

In accordance with a twenty-ninth aspect of the present invention, in the data reception step in the seventeenth aspect, the document data is supplied from a client via a network.

In accordance with a thirtieth aspect of the present invention, in the seventeenth aspect, the document publication method further comprises a publication report step. In the publication report step, a requester who requested the publication of the document data is informed of a document ID and publication time of the document data.

In accordance with thirty-first through forty-fifth aspects of the present invention, there are provided computer-readable record mediums storing programs for instructing a computer to execute the document publication method of the sixteenth through thirtieth aspects of the present invention.

### BRIEF DESCRIPTION OF THE DRAWINGS

The objects and features of the present invention will become more apparent from the consideration of the following detailed description taken in conjunction with the accompanying drawings, in which:

FIG. 1 is a block diagram for explaining a document publication system in accordance with a first embodiment of the present invention;

FIG. 2 is a table showing an example of the contents of a management table of the document publication system of FIG. 1;

FIG. 3 is a flow chart showing an example of the operation of a data reception section of the document publication system of FIG. 1;

FIG. 4 is a flow chart showing an example of the operation of a data registration control section of the document publication system of FIG. 1 when the data registration control section received an inventor ID from the data reception section;

FIG. 5 is a flow chart showing an example of the operation of a data publication section of the document publication system of FIG. 1;

FIG. 6 is a flow chart showing an example of the operation of a certificate issuing section of the document publication system of FIG. 1;

FIG. 7 is a flow chart showing an example of the operation of the data registration control section when the data registration control section received a document ID from the certificate issuing section; and

FIG. 8 is a block diagram for explaining a document publication system in accordance with a second embodiment of the present invention.

### DESCRIPTION OF THE PREFERRED EMBODIMENTS

Referring now to the drawings, a description will be given in detail of preferred embodiments in accordance with the present invention.

In the following explanation, an expression “publish information” means an act for opening the information to the public so that the information can be referred to by an indefinite number of people. A term “idea” means a new invention or device that can be regarded as an object of a patent right etc. A term “inventor” means a person who invented or devised the idea. An expression “publication of an idea” means an act for publishing information concerning the idea. In the following, an explanation concerning document publication systems and document publication methods in accordance with the present invention will be given assuming that document data concerning an idea is published, for example.

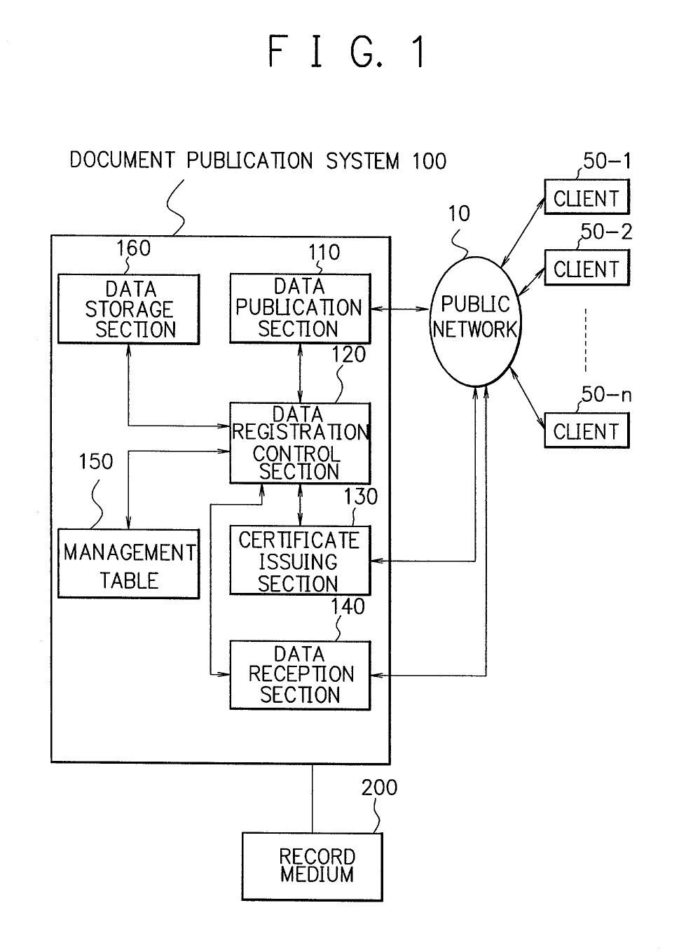

FIG. 1 is a block diagram for explaining a document publication system in accordance with a first embodiment of the present invention. Referring to FIG. 1, a document publication system 100, a record medium 200, a public network 10 and clients 50-1˜50-n are shown. The document publication system 100 is constructed so as to be capable of communicating information with the clients 50-1˜50-n via the public network 10. The public network 10 is implemented by, for example, the Internet. The clients 50-1˜50-n are implemented by, for example, personal computers having modems.

The document publication system 100, which is provided and managed by a provider of a service in accordance with the present invention, is implemented by, for example, a computer and appropriate software. The document publication system 100 includes a data publication section 110, a data registration control section 120, a certificate issuing section 130, a data reception section 140, a management table 150 and a data storage section 160.

The data reception section 140 has functions for receiving document data concerning ideas (document data in which ideas are described) which are supplied from the clients 50-1˜50-n via the public network 10.

The data registration control section 120 has functions for storing the document data received by the data reception section 140 in files in the data storage section 160. The data registration control section 120 also has functions for managing “publication time” of the document data (that is, the date and time when the idea described in the document data was made public known) by use of the management table 150.

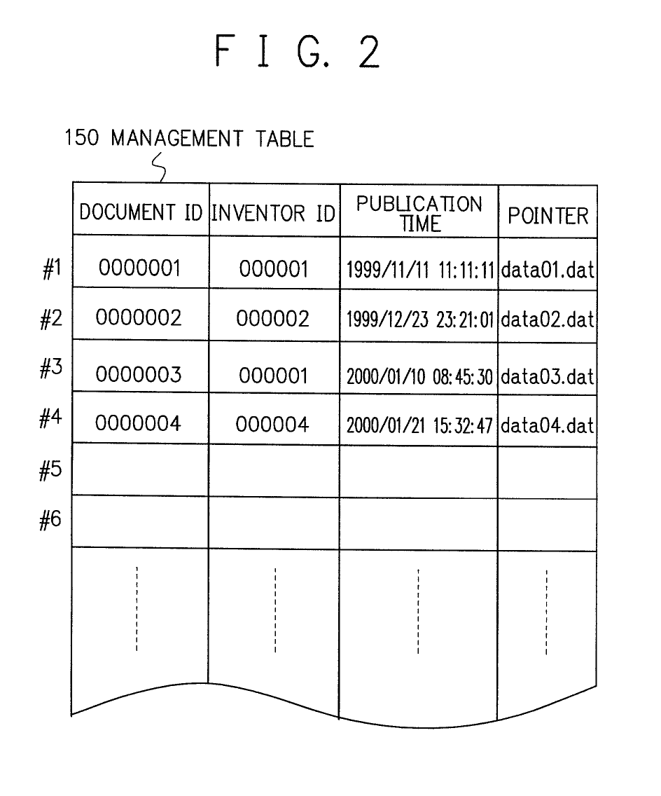

FIG. 2 is a table showing an example of the contents of the management table 150. In the management table 150 shown in FIG. 2, a “DOCUMENT ID” for discriminating between document data, an “INVENTOR ID” for discriminating between inventors, “PUBLICATION TIME” for indicating the date and time (year/month/day/time) of the publication of the document data, and a “POINTER” for indicating a file in the data storage section 160 in which the document data is stored, are stored with respect to each document data. For example, the first entry #1 of the management table 150 of FIG. 2 indicates that the publication time of document data of a document ID “0000001” is 11:11:11 of Nov. 11, 1999, and the filename of a file storing the document data is “data01.dat”, and the inventor ID of the inventor concerning the document data is “000001”.

The data publication section 110 has functions for publishing the document data received by the data reception section 140 by use of the public network 10.

For publishing the document data, the data publication section 110 can send the document data to the clients 50-1˜50-n via the public network 10 as an e-mail server on the Internet. The clients 50-1˜50-n can be implemented by clients (computers) that are provided to public facilities such as public libraries so that the document data supplied from the document publication system 100 can be referred to by an indefinite number of people, or clients (computers) owned by users of the document publication system 100 who want the distribution of the document data concerning ideas.

It is also possible to let the data publication section 110 send document data to a client (50-1˜50-n) when the client requested to refer to the document data, in the same way as a Web server. In this case, the data publication section 110 may register link information concerning the published data with data search facilities which are used by people for searching data on the public network 10 (such as search engines on the Internet) in order to enhance the effects of the publication.

The certificate issuing section 130 has functions for supplying information for verifying or proving the publication time of the document data (that is, the date and time when the idea described in the document data was made public known) to requesters.

The record medium 200 (data storage disk, semiconductor memory, magnetic record medium, etc.) stores a program for instructing a computer to execute the operation of the document publication system 100. The program which is read out from the record medium 200 is loaded onto the computer and controls the operation of the computer, thereby the data publication section 110, the data registration control section 120, the certificate issuing section 130 and the data reception section 140 are implemented on the computer.

In the following, the operation of the document publication system of FIG. 1 will be explained in detail. The operation of the document publication system includes two phases: (1) registration and publication of idea, and (2) verification of the publication time of the idea. The two phases will hereafter be explained in detail.

(1) Idea Registration/Publication Phase

An inventor who intends to publish his/her idea first operates a client 50-k (1≦k≦n) and thereby establishes connection with the document publication system 100 via the public network 10. Subsequently, the inventor operating the client 50-k sends a data registration request to the document publication system 100 and thereafter sends document data (in which the idea to be published has been described) to the document publication system 100. Incidentally, the data registration request contains an inventor ID that has been assigned to the inventor.

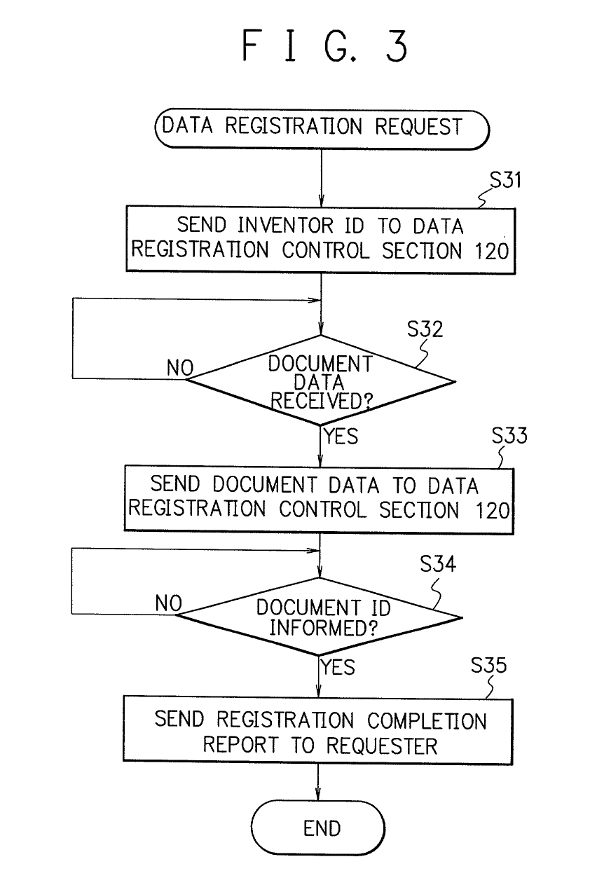

The data reception section 140 of the document publication system 100 which received the data registration request extracts the inventor ID (“000003”, for example) from the data registration request and sends the extracted inventor ID to the data registration control section 120 (step S31 of FIG. 3). Subsequently, the data reception section 140 receives the document data (“Yes” in step S32) and sends the received document data to the data registration control section 120 (step S33).

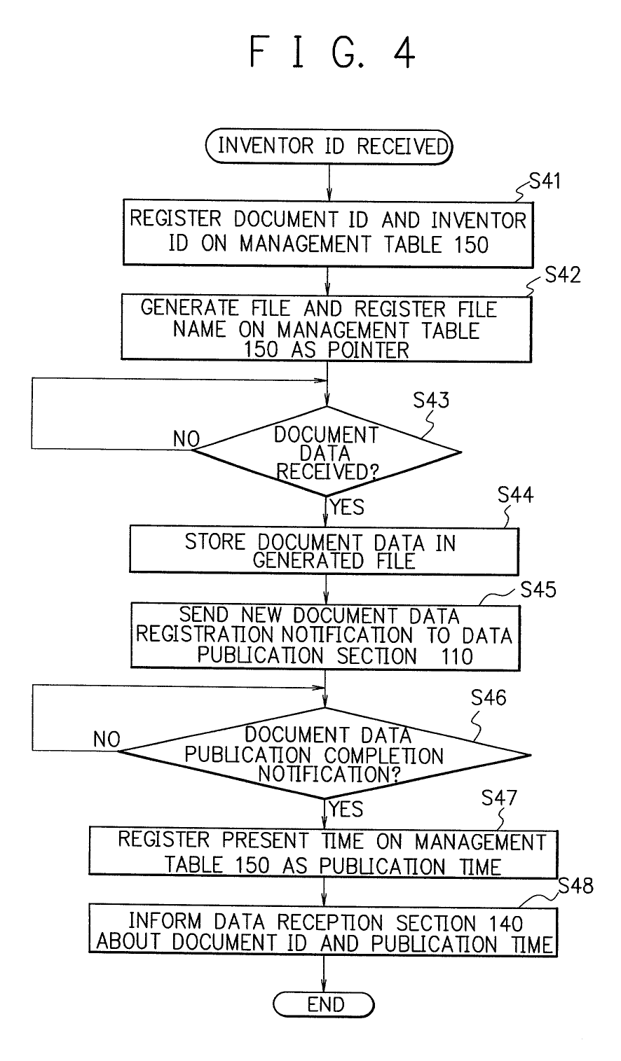

The data registration control section 120 which received the inventor ID “000003” generates a new document ID (“0000005”, for example), and stores the document ID “0000005” and the inventor ID “000003” in an idle entry (idle area) of the management table 150 having the smallest entry number (step S41 of FIG. 4). If we assume that the current status of the management table 150 is as shown in FIG. 2, the data registration control section 120 registers the document ID “0000005” and the inventor ID “000003” in an entry #5 of the management table 150.

Subsequently, the data registration control section 120 generates a new file in the data storage section 160 and registers the filename (“data05.dat”, for example) of the new file in the entry #5 of the management table 150 as a pointer (step S42). When the document data is supplied from the data reception section 140 (“Yes” in step S43), the data registration control section 120 stores the document data (and the document ID “0000005” generated in the step S41 added together) in the file “data05.dat” (step S44), and sends a new document data registration notification to the data publication section 110 (step S45). Incidentally, the new document data registration notification includes the filename “data05.dat” of the file containing the document data.

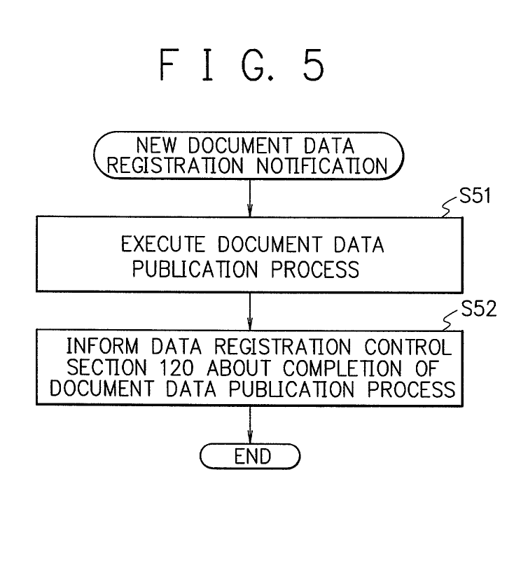

The data publication section 110 which received the new document data registration notification executes a document data publication process (step S51 of FIG. 5) and thereby publishes the newly registered document data through the public network 10 (step S51).

As a concrete method for the document data publication process, in the case where the public network 10 is the Internet, a memory area that can be referred to by the clients 50-1˜50-n in the Internet is prepared in the document publication system 100, and the newly registered document data (the contents of the file having the filename “data05.dat” contained in the new document data registration notification) is copied to the prepared area as added data, or the area (in which the file “data05.dat” containing the newly registered document data exists) can also be designated as an area that can be referred to by the clients 50-1˜50-n connected to the Internet (by displaying as a link on a home page, for example). It is also possible to send the newly registered document data together with its document ID to specific clients 50-i which have been installed in public facilities (such as public libraries) through the public network 10. In this case, the specific client 50-i which received the newly registered document data together with the document ID stores them in its storage unit such as an HDD (Hard Disk Drive), and displays the document data and the document ID when there is a request for the reference to the document data stored in the storage unit.

After the document data publication process is completed, the data publication section 110 informs the data registration control section 120 about the completion of the document data publication process (step S52).

The data registration control section 120 which received the information (document data publication completion notification) from the data publication section 110 (“Yes” in step S46 of FIG. 4) registers the present time T (year/month/day/time) in the entry #5 of the management table 150 as the publication time (step S47), and informs the data reception section 140 about the document ID “0000005” and the publication time T (step S48).

Due to the information from the data registration control section 120, the judgment in step S34 of FIG. 3 becomes “Yes”, and thus the data reception section 140 sends a registration completion report (containing the document ID “0000005” and the publication time T) to the client 50-k that requested the document publication (step S35).

By the registration completion report, the inventor using the client 50-k recognizes that the document data has been registered and published successfully. The document ID “0000005” contained in the registration completion report will be used for designating the document data containing the idea when verification of the publication time of the idea became necessary.

Incidentally, while the document data containing the idea to be published was sent by the inventor to the document publication system 100 via the public network 10 in the above explanation, the document data can also be sent to the document publication system 100 by sending a record medium (magnetic disk, optical disk, paper, etc. in which the document data has been recorded) to the provider or manager of the document publication system 100 by mail, package delivery service, etc.

In this case, the provider or manager of the document publication system 100 inputs the data registration request containing the inventor ID to the data reception section 140 by manual operation by use of an data input device (such as a keyboard), and thereafter inputs the document data to the data reception section 140 by use of a data reading device (such as a scanner) depending on the type of the record medium storing the document data. Subsequently, the data reception section 140 sends the inventor ID (contained in the data registration request inputted by use of the data input device) and the document data (inputted by use of the data reading device) to the data registration control section 120. When the document ID and the publication time T (of the document data whose registration and publication have been completed) are informed by the data registration control section 120, the data reception section 140 outputs the registration completion report (containing the document ID and the publication time T) by use of an output device (printer, display, etc.) and informs the manager of the document publication system 100 about the completion of the registration and publication of the document data. The manager of the document publication system 100 who received the information records the registration completion report (containing the document ID and the publication time T) in a record medium (paper, magnetic disk, etc.) and sends the record medium to the requester by mail, package delivery service, etc. It is also possible to inform the requester about the completion of the registration and publication of the document data and the document ID by use of telephone, facsimile, etc.

While the data reception section 140 in the above explanation received the document data and sent the document data to the data registration control section 120 just as it is, it is also possible to let the data reception section 140 check whether or not the data format of the document data is included in predetermined formats (HTML text, MS-DOS text) and send the document data to the data registration control section 120 after converting the document data to a predetermined format if the data format is not included in the predetermined formats. In this case, clients which refer to document data registered with the document publication system 100 are not required to have programs for referring to document data of other formats, thereby costs for the clients can be reduced.

While the information concerning the registered document data were supplied to an indefinite number of people who uses clients 50-1˜50-n that are connected to the public network 10 in the above explanation, it is also possible to limit the receivers of the information to one or more specific user groups. In this case, the information is supplied to one or more specific user groups requiring information of new ideas, or the information is placed so as to be referred to by one or more such specific user groups. By narrowing the range of the publication, the value of the information of the ideas can be raised while attaining the publication of the ideas.

(2) Idea Publication Time Verification Phase

When the inventor of an idea needs to verify or prove the fact of the publication and the publication time, the inventor conducts a verification request to the document publication system 100. The cases where the inventor needs to verify the fact of the publication and the publication time include cases where opposition or trial for invalidation of patent has to be claimed with regard to a patent right of another person and the verification is regarded as effective for the opposition or trial. Concretely, the cases include a case where a person published his/her idea and thereafter another person made an application for patent, utility model, etc. with regard to an idea that is the same as or similar to the published idea and thereafter a patent right etc. is granted to the application.

The inventor of an idea who needs the verification of the publication time of the idea that has already been registered with the document publication system 100 as document data sends a verification request to the document publication system 100 via the public network 10 by use of a client 50-k. The verification request contains the document ID (“0000003”, for example) of the document data in which the idea needing the publication time verification has been described.

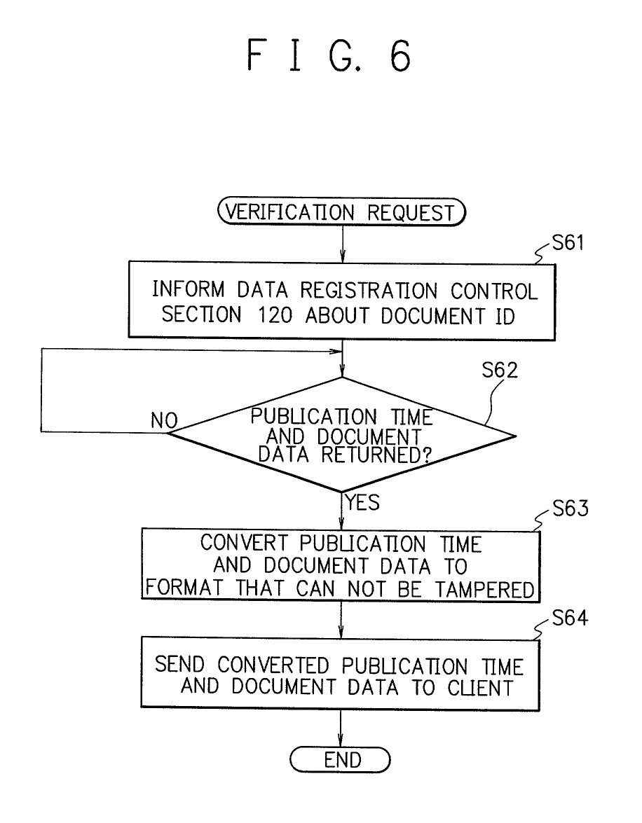

The certificate issuing section 130 of the document publication system 100 which received the verification request from the client 50-k informs the data registration control section 120 about the document ID “0000003” contained in the verification request (step S61 of FIG. 6).

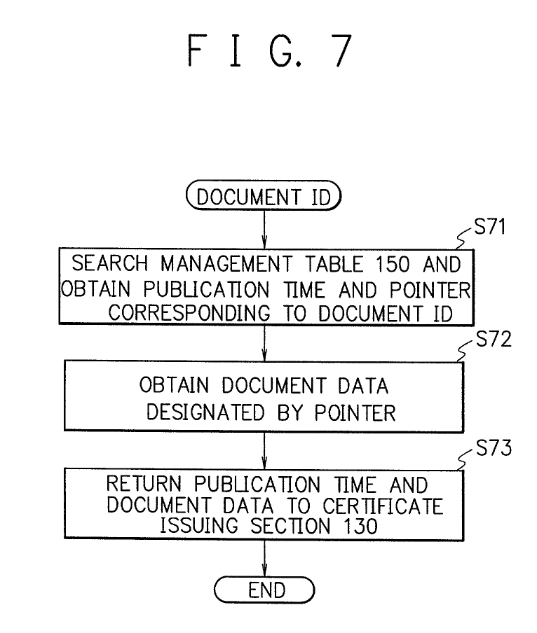

The data registration control section 120 which received the document ID “0000003” from the certificate issuing section 130 searches the management table 150 by use of the document ID “0000003”, and thereby obtains the publication time “2000/01/10 08:45:30” and the pointer “data03.dat” corresponding to the document ID “0000003” from the entry #3 of the management table 150 (step S71 of FIG. 7).

Subsequently, the data registration control section 120 obtains document data (having the document ID “0000003”) that is designated by the pointer “data03.dat” from the data storage section 160 (step S72) and returns the document data and the publication time “2000/01/10 08:45:30” obtained in the step S71 to the certificate issuing section 130 (step S73).

The certificate issuing section 130 which received the document data and the publication time “2000/01/10 08:45:30” from the data registration control section 120 (“Yes” in step S62 of FIG. 6) converts them to a format capable of preventing tampering of data (step S63) and sends the converted document data and publication time as a certificate to the client 50-k via the public network 10 (step S64). The format capable of preventing tampering of data means a format by which tampering of the contents of the document data and the publication time by the requester of the verification is prevented. Such format includes document data to which a digital signature has been added.

Incidentally, in the case where the document data has been published by the data publication section 110 together with the document ID, the certificate issuing section 130 may also send the document ID and the publication time to the client 50-k via the public network 10 as the certificate, after converting the certificate to a format capable of preventing tampering of data.

Thereafter, the requester of the verification is enabled to prove and claim the fact of the publication of his/her idea based on the certificate (the document data and the publication time, or the document ID and the publication time) supplied from the document publication system 100 to the client 50-k.

While the verification request (containing the document ID) of the requester was sent from the client 50-k to the document publication system 100 via the public network 10 in the above explanation, it is also possible to let the requester send a document, record medium, etc. in which the verification request containing the document ID has been recorded to the provider or manager of the document publication system 100 by mail, package delivery service, etc. It is also possible to let the requester conduct the verification request by reporting the document ID by use of telephone, facsimile, etc.

In such cases, the provider or manager of the document publication system 100 inputs the verification request containing the document ID to the certificate issuing section 130 by manual operation by use of an data input device (such as a keyboard). The certificate issuing section 130 which received the verification request sends the document ID included in the verification request to the data registration control section 120. When the document data and the publication time are supplied from the data registration control section 120 as reply, the certificate issuing section 130 informs the manager of the document publication system 100 about the reply by displaying a message on a display etc. Thereafter, the manager instructs the certificate issuing section 130 to print the document data and the publication time by use of a printer, or to convert the document data and the publication time into a format capable of preventing tampering of data and output the converted data to a record medium such as a magnetic disk. In the case where the document data and the publication time are printed by a printer, the manager puts his/her seal on the printout and sends the sealed printout to the requester of the verification. In the case where the document data and the publication time are outputted to a record medium, the record medium, in which the document data and the publication time have been recorded in a format that can not tampered, is sent to the requester by mail, package delivery service, etc.

While the requester of the verification concerning an idea has been assumed to be the inventor of the idea in the above explanation, the verification can be requested by any people. For example, a third party who happened to see document data that has been published by the data publication section 110 via the public network 10 can request the verification of the publication time of the document data.

By the above two phases: (1) idea registration/publication phase and (2) idea publication time verification phase, the inventor of an idea can publish the idea and if the idea is new and novel, the right to effectuate the idea as vocation can be secured for the inventor.

As described above, by the document publication system and the document publication method in accordance with the first embodiment of the present invention, publication of a plurality of ideas and management of data concerning the ideas are conducted by the document publication system 100 systematically by batch processing. Therefore, the publication of ideas can be done at lower costs in comparison with the conventional cases where the inventors publish their ideas individually. The verification of the publication time, which has been difficult for a private individual to conduct, is made possible by the idea publication time verification process which is conducted by the provider of the document publication system 100 as a third party.

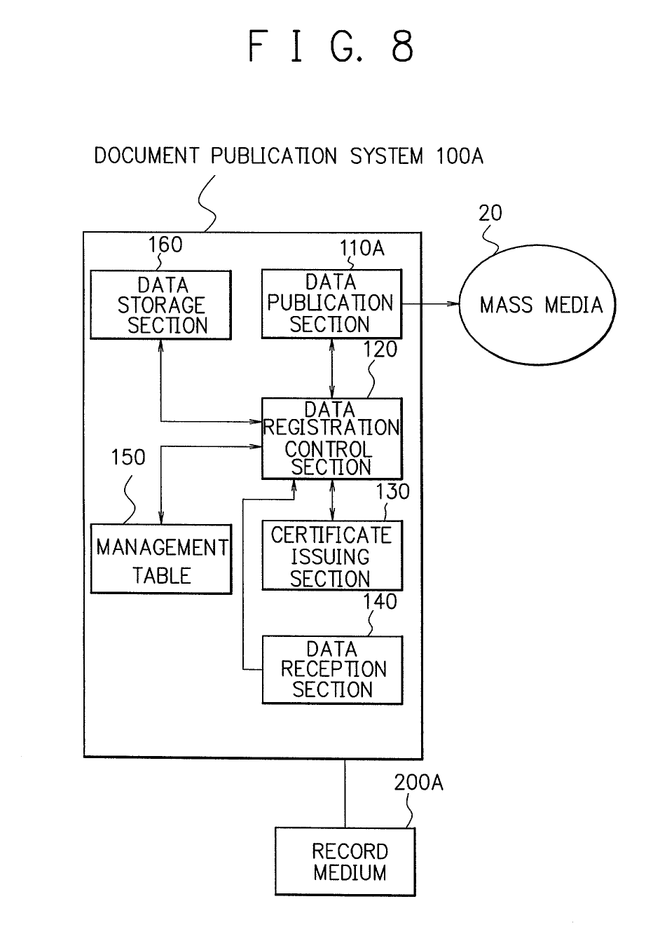

FIG. 8 is a block diagram for explaining a document publication system in accordance with a second embodiment of the present invention. While the public network 10 (a bidirectional communication network such as the Internet) was employed for the publication of ideas in the first embodiment, mass media 20 can also be employed for the publication of ideas as shown in FIG. 8. The mass media 20 shown in FIG. 8 means paths for transferring information by use of existing mass media such as television, radio, satellite broadcasting, newspaper, magazines, etc. The document publication system 100A shown in FIG. 8 has two differences from the document publication system 100 of FIG. 1: the data publication section 110A and the record medium 200A. The record medium 200A (which is implemented by a data storage disk, semiconductor memory, magnetic record medium, etc.) stores a program for instructing a computer to execute the operation of the document publication system 100A. The program which is read out from the record medium 200A is loaded onto the computer and controls the operation of the computer, thereby the data publication section 110A, the data registration control section 120, the certificate issuing section 130 and the data reception section 140 are implemented on the computer.

In the second embodiment, the data publication section 110A conducts the publication of the ideas by publishing document data (in which the ideas have been described) through the mass media 20. In the case where television is used, the publication can be conducted through teletext. In the case where newspaper is used, the contents of the document data can be published on the newspaper as articles. Processes after the publication are the same as those of the first embodiment.

Also in the second embodiment, publication of a plurality of ideas and management of data concerning the ideas are conducted by the document publication system 100A systematically by batch processing. Therefore, the publication of ideas can be done at lower costs in comparison with the conventional cases where the inventors publish their ideas individually. The verification of the publication time, which has been difficult for a private individual, is made possible by the idea publication time verification process which is conducted by the provider of the document publication system 100A as a third party.

As set forth hereinabove, in the document publication system and the document publication method in accordance with the present invention, document data in which ideas are described can be published (opened to the public) at low costs, thereby the inventor of a new idea can secure the right to effectuate the idea as vocation easily and at a low cost.

The verification of the publication time of an idea can be done at a low cost, thereby the user of the document publication system can easily carry out a necessary procedure according to patent statute etc. based on the publication time verification.

Tampering and abuse of the publication time certificate (including the publication time of the document data concerning the idea) which is supplied to the requester can be avoided, since the certificate issuing section 130 sends the publication time and the document data (certificate) to the requester after converting them to a format capable of preventing tampering of data.

The costs for clients for referring to document data that have been registered with the document publication system 100 can be reduced, since the registration of document data (of a different format) is executed after converting the document data to a predetermined format. The clients for referring to the document data are not required to have programs for referring to document data of other formats and thereby the cost for the clients can be reduced.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A document publication system which records each document data that is inputted as an object of publication, publishes the document data by use of a public medium while recording publication time of the document data, and issues a certificate concerning the publication time of document data to a requester according to a publication time verification request by the requester designating the document data.

2. A document publication system for opening documents to the public, comprising:
a data reception means for receiving document data that is inputted as an object of publication;
a data publication means for publishing the document data received by the data reception means by use of a public medium;
a data registration control means for recording the document data received by the data reception means and recording publication time of the document data by the data publication means; and
a certificate issuing means for issuing a certificate concerning the publication time of document data to a requester according to a publication time verification request by the requester designating the document data.

3. A document publication system as claimed in claim 2, wherein the certificate issuing means converts the designated document data and data concerning the publication time of the designated document data to a format capable of preventing tampering of data and thereafter provides the converted data to the requester as the certificate.

4. A document publication system as claimed in claim 3, wherein the certificate issuing means adds a digital signature to the designated document data and the data concerning the publication time and provides the data with the digital signature to the requester as the certificate.

5. A document publication system as claimed in claim 2, wherein:
the data publication means publishes the document data together with a document ID of the document data, and
the certificate issuing means converts the document ID of the designated document data and data concerning the publication time of the designated document data to a format capable of preventing tampering of data and thereafter provides the converted data to the requester as the certificate.

6. A document publication system as claimed in claim 5, wherein the certificate issuing means adds a digital signature to the document ID of the designated document data and the data concerning the publication time and provides the data with the digital signature to the requester as the certificate.

7. A document publication system as claimed in claim 2, further comprising a format conversion means for converting the format of the document data received by the data reception means to a predetermined format when the format of the document data is not the predetermined format.

8. A document publication system as claimed in claim 2, wherein the data publication means uses a public network as the public medium.

9. A document publication system as claimed in claim 8, wherein the data publication means uses the Internet as the public network.

10. A document publication system as claimed in claim 2, wherein the data publication means uses mass media as the public medium.

11. A document publication system as claimed in claim 10, wherein the data publication means uses broadcasting as the mass media.

12. A document publication system as claimed in claim 10, wherein the data publication means uses newspaper and/or magazines as the mass media.

13. A document publication system as claimed in claim 2, wherein the document data is document data concerning an idea invented or devised by a person.

14. A document publication system as claimed in claim 2, wherein the data reception means receives the document data from a client via a network.

15. A document publication system as claimed in claim 2, further comprising a publication report means for informing a requester who requested the document data publication about a document ID and publication time of the document data.

16. A document publication method in which each document data that is inputted as an object of publication is recorded and published by use of a public medium while recording publication time of the document data, and a certificate concerning the publication time of document data is issued to a requester according to a publication time verification request by the requester designating the document data.

17. A document publication method for opening documents to the public, comprising the steps of:
a data reception step in which document data that is inputted as an object of publication is received;
a data publication step in which the document data received in the data reception step is published by use of a public medium;
a data registration control step in which the document data received in the data reception step is recorded and publication time of the document data by the data publication means is recorded; and
a certificate issuing step in which a certificate concerning the publication time of document data is issued to a requester according to a publication time verification request by the requester designating the document data.

18. A document publication method as claimed in claim 17, wherein in the certificate issuing step, the designated document data and data concerning the publication time of the designated document data are converted to a format capable of preventing tampering of data and thereafter the converted data is provided to the requester as the certificate.

19. A document publication method as claimed in claim 18, wherein in the certificate issuing step, a digital signature is added to the designated document data and the data concerning the publication time, and the data with the digital signature is provided to the requester as the certificate.

20. A document publication method as claimed in claim 17, wherein:
in the data publication step, the document data is published together with a document ID of the document data, and
in the certificate issuing step, the document ID of the designated document data and data concerning the publication time of the designated document data are converted to a format capable of preventing tampering of data and thereafter the converted data is provided to the requester as the certificate.

21. A document publication method as claimed in claim 20, wherein in the certificate issuing step, a digital signature is added to the document ID of the designated document data and the data concerning the publication time, and the data with the digital signature is provided to the requester as the certificate.

22. A document publication method as claimed in claim 17, further comprising a format conversion step in which the format of the document data received in the data reception step is converted to a predetermined format when the format of the document data is not the predetermined format.

23. A document publication method as claimed in claim 17, wherein a public network is used as the public medium in the data publication step.

24. A document publication method as claimed in claim 23, wherein the Internet is used as the public network in the data publication step.

25. A document publication method as claimed in claim 17, wherein mass media is used as the public medium in the data publication step.

26. A document publication method as claimed in claim 25, wherein broadcasting is used as the mass media in the data publication step.

27. A document publication method as claimed in claim 25, wherein newspaper and/or magazines are used as the mass media in the data publication step.

28. A document publication method as claimed in claim 17, wherein the document data is document data concerning an idea invented or devised by a person.

29. A document publication method as claimed in claim 17, wherein in the data reception step, the document data is supplied from a client via a network.

30. A document publication method as claimed in claim 17, further comprising a publication report step in which a requester who requested the publication of the document data is informed of a document ID and publication time of the document data.

31. A computer-readable record medium storing a program for instructing a computer to execute a document publication process, in which each document data that is inputted as an object of publication is recorded and published by use of a public medium while recording publication time of the document data, and a certificate concerning the publication time of document data is issued to a requester according to a publication time verification request by the requester designating the document data.

32. A computer-readable record medium storing a program for instructing a computer to execute a document publication process for opening documents to the public, wherein the document publication process comprises the steps of:
a data reception step in which document data that is inputted as an object of publication is received;
a data publication step in which the document data received in the data reception step is published by use of a public medium;
a data registration control step in which the document data received in the data reception step is recorded and publication time of the document data by the data publication means is recorded; and
a certificate issuing step in which a certificate concerning the publication time of document data is issued to a requester according to a publication time verification request by the requester designating the document data.

33. A computer-readable record medium as claimed in claim 32, wherein in the certificate issuing step, the designated document data and data concerning the publication time of the designated document data are converted to a format capable of preventing tampering of data and thereafter the converted data is provided to the requester as the certificate.

34. A computer-readable record medium as claimed in claim 33, wherein in the certificate issuing step, a digital signature is added to the designated document data and the data concerning the publication time, and the data with the digital signature is provided to the requester as the certificate.

35. A computer-readable record medium as claimed in claim 32, wherein:
in the data publication step, the document data is published together with a document ID of the document data, and
in the certificate issuing step, the document ID of the designated document data and data concerning the publication time of the designated document data are converted to a format capable of preventing tampering of data and thereafter the converted data is provided to the requester as the certificate.

36. A computer-readable record medium as claimed in claim 35, wherein in the certificate issuing step, a digital signature is added to the document ID of the designated document data and the data concerning the publication time, and the data with the digital signature is provided to the requester as the certificate.

37. A computer-readable record medium as claimed in claim 32, wherein the document publication process further comprises a format conversion step in which the format of the document data received in the data reception step is converted to a predetermined format when the format of the document data is not the predetermined format.

38. A computer-readable record medium as claimed in claim 32, wherein a public network is used as the public medium in the data publication step.

39. A computer-readable record medium as claimed in claim 38, wherein the Internet is used as the public network in the data publication step.

40. A computer-readable record medium as claimed in claim 32, wherein mass media is used as the public medium in the data publication step.

41. A computer-readable record medium as claimed in claim 40, wherein broadcasting is used as the mass media in the data publication step.

42. A computer-readable record medium as claimed in claim 40, wherein newspaper and/or magazines are used as the mass media in the data publication step.

43. A computer-readable record medium as claimed in claim 32, wherein the document data is document data concerning an idea invented or devised by a person.

44. A computer-readable record medium as claimed in claim 32, wherein in the data reception step, the document data is supplied from a client via a network.

45. A computer-readable record medium as claimed in claim 32, wherein the document publication process further comprises a publication report step in which a requester who requested the publication of the document data is informed of a document ID and publication time of the document data.
